(19) United States
(12) Patent Application Publication
(10) Pub. No.: US 2026/0271918 A1
(43) Pub. Date: Sep. 17, 2026

(54) A STABLE AGROCHEMICAL COMPOSITION

(71) Applicant: UPL LIMITED, Mumbai (IN)

(72) Inventors: Popat Ganesh Chavan, Mumbai (IN); Dev Varta Mukherjee, Mumbai (IN)

(73) Assignee: UPL LIMITED, Mumbai (IN)

(21) Appl. No.: 19/168,871

(22) PCT Filed: Mar. 26, 2024
(86) PCT No.: PCT/IB2024/052880

§ 371 Date: Sep. 25, 2025

(30) Foreign Application Priority Data
Mar. 30, 2023 (IN) 202321023877

(51) Int. Cl. A01N 25/04; A01N 43/56; A01N 43/653; A01N 47/14; A01P 3/00

(52) U.S. Cl. CPC A01N 25/04; A01N 43/56; A01N 43/653; A01N 47/14; A01P 3/00

(57) ABSTRACT

The present invention relates to a stable agrochemical composition comprising at least one pyrazolecarboxamide fungicide or a derivative thereof; at least one additional fungicide or a derivative thereof; an unsaturated lipid or a derivative thereof; and an additive. The present invention also discloses a process for preparation, a method of application and use of the agrochemical composition.

### FIELD OF THE INVENTION

The present invention relates to a stable agrochemical composition comprising a pyrazolecarboxamide fungicide. The present invention more particularly relates to a stable agrochemical composition comprising a pyrazolecarboxamide fungicide and its combinations in the form of suspension concentrates (SC).

### BACKGROUND OF THE INVENTION

Chemically, pyrazole carboxamide compounds are succinate dehydrogenase inhibitors (SDHIs) known for preventive, curative and systemic controlling effects on plant microbes. The enzyme succinate dehydrogenase is linked to the inner mitochondrial membrane that participates in the cellular respiration process. Inhibitors of succinate dehydrogenase enzyme are used as fungicides in the agricultural field and are known for their high level of biological activity and broad-spectrum action. Pyrazole carboxamide compounds are active substances used in fungicidal products to control certain fungi and molds affecting crops. Fluindapyr is a pyrazole carboxamide compound belonging to the class of N-indanyl-pyrazolecarboxamides and is represented by formula (I), shown below:

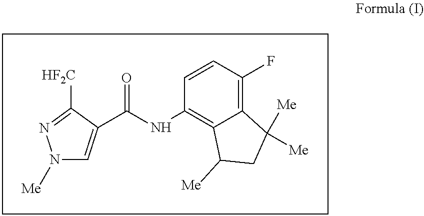

Numerous formulations containing pyrazolecarboxamides are known in the art for use in the agrochemical field. Such formulations can be in the form of solid or liquid preparations, or in the form of solid suspensions in liquids.

For the better utilization of an agrochemical ingredient, formulations have to be able to solubilize or disperse, or they have to give rise to stable emulsions when diluted in specific volumes of water. Suspension concentrate (SC) is one of the conventional and preferred formulation to formulate hydrophobic active ingredients. The suspension concentrate is a specific type of liquid formulation wherein one or more active ingredients/excipients in the form of solid particles are dispersed homogeneously in water, which is subsequently diluted with appropriate volumes of water before being applied to the cultivation area.

Unlike other types of formulation, the aqueous suspension can have physical instability problems over time due to phenomena of recrystallization, flocculation, phase separation or an increase in viscosity, which in turn causes homogeneity problems relating to the application of the active ingredients, difficulties in diluting and pouring the product and problems relating to the active substance's penetration, which make the fungicidal treatment less effective.

It becomes further challenging when multiple active ingredients are to be combined into a single system. For instance, suspension concentrate of multiple active ingredients require a fine balance between suspensibility, viscosity and free of other factors such as undesired crystal growth to achieve the desired performance. Moreover, each active ingredient needs to preserve its own identity without being degraded due to presence of diverse chemical substances within the system.

Pyrazole carboxamide compounds are frequently combined with other fungicides such as strobilurin fungicides or azole fungicides to broaden the spectrum of activity.

Prothioconazole, having the IUPAC name 2-[2-(1-chlorocyclopropyl)-3-(2-chlorophenyl)-2-hydroxypropyl]-2,4-dihydro-1,2,4-triazole-3-thioneis is a synthetic compound of the triazole family, which are a class of systemic fungicides that on contact with the plant enter it and spread from the site of application to untreated or newly grown area, thereby uprooting existing fungi and/or protecting the plant from future fungal infestations. Tebuconazole is another azole fungicide chemically known as (RS)-1-p-chlorophenyl-4,4-dimethyl-3-(1H-1,2,4-triazol-1-ylmethyl)=pentan-3-ol. Many agricultural formulations comprising tebuconazole are used for broad-spectrum disease control.

Furthermore, Mancozeb is a dithiocarbamate fungicide; and is a coordination product of a zinc ion and manganese ethylene-1,2-bis-dithiocarbamate polymer, having the following chemical structure as formula (II):

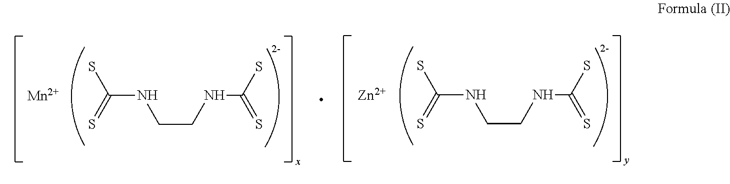

Mancozeb is a protective fungicide having high efficacy, low toxicity, low residue, and broad fungicidal spectrum, which is mainly used for controlling various fungal diseases on wheat, fruits, and vegetables.

With an objective of broadening the spectrum of activity, combining active ingredients with diversified chemical classes is a common practice and at the same time, handling distinctive physico-chemical profile of individual active ingredients in a common system is challenging. Therefore, there is a need to develop a stable composition having better physico-chemical characteristics, such as homogeneity of the components, better suspensibility, absence of flocculation or recrystallization phenomena, optimal viscosity, with these characteristics remaining stable over time.

### OBJECTIVES OF THE INVENTION

An objective of the present invention is to provide a stable agrochemical composition of a pyrazolecarboxamide fungicide or a derivative thereof, in combination with other active ingredients.

Another objective of the present invention is to provide a stable agrochemical composition of a pyrazolecarboxamide fungicide or a derivative thereof and other active ingredients, with consistent viscosity.

Another objective of the present invention is to provide a stable agrochemical composition of a pyrazolecarboxamide fungicide or a derivative thereof and other active ingredients, with low temperature stability.

Another objective of the present invention is to provide a stable agrochemical composition of a pyrazolecarboxamide fungicide or a derivative thereof and other active ingredients, devoid of crystal growth or caking.

Yet another objective of the present invention is to provide a method of controlling pests using a stable agrochemical composition of a pyrazolecarboxamide fungicide or a derivative thereof in combination with other active ingredients.

### SUMMARY OF THE INVENTION

In an aspect, the present invention provides a stable agrochemical composition comprising:
(a) at least one pyrazolecarboxamide fungicide or a derivative thereof;
(b) at least one additional fungicide or a derivative thereof;
(c) an unsaturated lipid or a derivative thereof; and
(d) an additive.

Another aspect of the present invention is to provide a stable agrochemical composition comprising:
(a) at least one pyrazolecarboxamide fungicide or a derivative thereof;
(b) at least one additional fungicide or a derivative thereof;
(c) an unsaturated lipid or a derivative thereof selected from esters of fatty acids with glycerol; and
(d) an additive selected from the group comprising clay, modified clay, high surface area silica, cellulose derivatives, or mixtures thereof.

Another aspect of the present invention provides a stable agrochemical composition comprising:
(a) at least one pyrazolecarboxamide fungicide or a derivative thereof;
(b) at least one additional fungicide selected from the group comprising dithiocarbamate, azole, benzimidazole, strobilurin, copper, copper compounds, or derivatives thereof;
(c) an unsaturated lipid selected from esters of fatty acids with glycerol; and
(d) an additive selected from the group comprising clay, modified clay, high surface area silica, starch derivatives, cellulose derivatives, or mixtures thereof.

In another aspect, the present invention provides a process of preparing the stable agrochemical composition comprising (a) at least one pyrazolecarboxamide fungicide or a derivative thereof; (b) at least one additional fungicide or a derivative thereof; (c) an unsaturated lipid or derivatives thereof; and (d) an additive; wherein said process comprises:
(a) mixing, and optionally blending and milling, at least one pyrazolecarboxamide fungicide or a derivative thereof, at least one additional fungicide or a derivative thereof, an unsaturated lipid or a derivative thereof, an additive and water to obtain a mixture;
(b) adding to the mixture of step (a), a separately prepared gel to obtain a stable agrochemical composition.

Another aspect of the present invention provides a method of controlling phytopathogenic fungal diseases by applying to plants or their locus or plant propagation material thereof, a stable agrochemical composition comprising: (a) at least one pyrazolecarboxamide fungicide or a derivative thereof; (b) at least one additional fungicide or a derivative thereof; (c) an unsaturated lipid; and (d) an additive.

Another aspect of the present invention provides use of the stable agrochemical composition as a fungicide.

### DETAILED DESCRIPTION OF THE INVENTION

The following description is provided to assist in a comprehensive understanding of exemplary embodiments of the invention. It includes various specific details to assist in that understanding but these are to be regarded as merely exemplary.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms used in the following description and claims are not limited to the bibliographical meanings but are merely used by the inventor to enable a clear and consistent understanding of the invention. Accordingly, it should be apparent to those skilled in the art that the following description of exemplary embodiments of the present invention are provided for illustration purpose only and not for limiting the scope of the invention as defined by the appended claims and their equivalents.

For the purposes of the present invention, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present invention in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term.

Prior to setting forth the present subject matter in detail, it may be helpful to provide definitions of certain terms used herein. Unless defined otherwise, all technical and scientific terms used herein have the same meaning as is commonly understood by one of skill in the art to which this subject matter pertains. The following definitions are provided for clarity.

Unless defined otherwise, all technical and scientific terms used herein have the same meaning as commonly understood by one of ordinary skill in the art to which this invention belongs. It must be noted that, as used in this specification, the singular forms “a”, “an” and “the” include plural referents unless the content clearly dictates otherwise.

As used herein, the terms “comprising”, “including”, “having”, “containing”, “involving”, and the like are to be understood to be open-ended, i.e., to mean including but not limited to. The terms “preferred” and “preferably” refer to embodiments of the invention that may afford certain benefits, under certain circumstances.

The aspects and embodiments described herein shall also be interpreted to replace the clause “comprising” with either “consisting of” or with “consisting essentially of” or with “consisting substantially of”.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. It is understood that where a parameter range is provided, all integers within that range, and tenths thereof, are also provided. For example, “0.1-80%” includes 0.1%, 0.2%, 0.3%, etc. up to 80%.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

As used herein, the term “agrochemical” is understood to denote an agricultural chemical such as pesticides, fungicides, insecticides, acaricides, herbicides, nematicides, plant growth regulators and can be used interchangeably.

As used herein, the term “fungicide” refers to the ability of a substance to decrease or inhibit growth of fungi or oomycetes.

As used herein the term “plant” or “crop” refers to whole plants, plant organs (e.g., leaves, stems, twigs, roots, trunks, limbs, shoots, fruits, etc.), plant cells, or plant seeds. This term also encompasses plant crops such as fruits. The term “plant” may further include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

The term “locus” as used herein denotes the vicinity or area designated for growth of a desired crop, and in which control of the growth and/or spread of undesirable vegetation is desired. The locus includes the vicinity of desired crop plants wherein undesirable vegetation growth has either occurred, is most likely to occur, or is yet to occur.

The salts referred to herein are agriculturally acceptable salts. As used herein, an “agriculturally acceptable salt” means a salt which is known and accepted for use in agricultural or horticultural use.

The term “plant propagation material” refers to the parts of the plant, such as seeds, which can be used for the propagation of the plant and vegetative plant material. There may be mentioned, e.g., the seeds (in the strict sense), roots, fruits, tubers, bulbs, rhizomes, parts of plants. Germinated plants or young plants, which may be transplanted after germination or after emergence from the soil.

The term “seed” embraces seeds and plant propagules of all kinds including but not limited to true seeds, seed pieces, suckers, corms, bulbs, fruit, tubers, grains, cuttings, cut shoots and the like and means in a preferred embodiment true seed.

The term “stable” referred to herein refers to chemical and/or physical stabilization of the composition in terms of achieving chemical stability of the active ingredient and desired suspensibility and dispersibility of the composition by maintaining homogeneity of the components that impart shelf life up to 2 years.

The term “control” or “controlling” fungus means to inhibit, and/or suppress the ability of fungus to grow and/or reproduce, or to limit fungus-related damage or loss in crop plants or denotes control and prevention of a disease. Controlling effects include all deviation from natural development, for example: killing, retardation, decrease of the fugal disease.

As used herein the term “unsaturated lipid or derivatives thereof” unless stated otherwise, means lipid or its derivatives, derived from any suitable source, containing more than 50% of unsaturated fatty acid or derivatives thereof, preferably more than 80% of unsaturated fatty acid or derivatives thereof. The term “unsaturated lipid” is used interchangeably with the term “unsaturated lipid or derivatives thereof” throughout the specification and shall have construed to have same meaning.

The term “additive” refers to a compound that imparts suitable viscosity to the stable agrochemical composition developed according to the present invention.

The term “derivative(s)” as used herein, refers to a salt, an ester or isomers of the active ingredient.

The inventors of the present invention found that a stable agrochemical composition of pyrazolecarboxamide fungicide with other fungicides can be successfully developed by addition of an unsaturated lipid or a derivative thereof, and an additive with characteristics of modifying the viscosity of the composition. The stable agrochemical composition is in the form of a suspension concentrate. The combination of unsaturated lipid or a derivative thereof, and an additive with characteristics of modifying the viscosity of the composition, effectively imparted homogeneity to the composition. It was found that compositions developed by using the additive and the unsaturated lipid or a derivative thereof, resulted into a composition exhibiting satisfactory stability parameters. It was observed that when a pyrazolecarboxamide fungicide such as fluindapyr is combined with other fungicides with higher density, the viscosity of the final composition increased substantially. The presence of an additive and an unsaturated lipid imparted structural stability and aided the structuring of the suspension concentrate composition which conventional thickeners alone failed to provide. The inventors of the present invention found that viscosity of the finished suspension concentrate composition remained quite stable at various temperatures, especially at low temperatures.

According to an embodiment, the present invention provides an agrochemical composition comprising:
(a) at least one pyrazolecarboxamide fungicide or a derivative thereof;
(b) at least one additional fungicide or a derivative thereof;
(c) an unsaturated lipid or a derivative thereof; and
(d) an additive.

According to an embodiment of the present invention, the pyrazolecarboxamide fungicide is selected from the group comprising benzovindiflupyr, bixafen, flubeneteram, fluindapyr, fluxapyroxad, furametpyr, inpyrfluxam, isopyrazam, penflufen, penthiopyrad, pydiflumetofen, sedaxane, or derivatives thereof.

According to an embodiment of the present invention, the pyrazolecarboxamide fungicide is selected from the group comprising benzovindiflupyr, bixafen, fluindapyr, fluxapyroxad, or derivatives thereof.

According to an embodiment of the present invention, the pyrazolecarboxamide fungicide is fluindapyr or a derivative thereof.

According to an embodiment of the present invention, the pyrazolecarboxamide fungicide is bixafen or a derivative thereof.

According to an embodiment of the present invention, the stable agrochemical composition comprises from about 0.1% w/w to about 30% w/w pyrazolecarboxamide fungicide of total weight of the composition.

According to an embodiment of the present invention, the stable agrochemical composition comprises from about 0.5% w/w to about 30% w/w pyrazolecarboxamide fungicide of total weight of the composition.

According to an embodiment of the present invention, the stable agrochemical composition comprises from about 1% w/w to about 30% w/w pyrazolecarboxamide fungicide of total weight of the composition.

According to an embodiment of the present invention, the stable agrochemical composition comprises from about 1% w/w to about 30% w/w fluindapyr of total weight of the composition.

In a preferred embodiment, the agrochemical composition comprises about 2.6% w/w fluindapyr of total weight of the composition.

In a preferred embodiment, the agrochemical composition comprises about 2.25% w/w fluindapyr of total weight of the composition.

In a preferred embodiment, the agrochemical composition comprises about 1.60% w/w fluindapyr of total weight of the composition.

According to an embodiment of the present invention, the stable agrochemical composition comprises from about 1% w/w to about 30% w/w bixafen of total weight of the composition.

In a preferred embodiment, the agrochemical composition comprises about 2.6% w/w bixafen of total weight of the composition.

According to an embodiment, the concentration of fluindapyr ranges from about 1 g/L to about 50 g/L.

In an embodiment, the concentration of fluindapyr ranges from about 15 g/L to about 35 g/L.

In a preferred embodiment, the concentration of fluindapyr is about 30 g/L.

In a preferred embodiment, the concentration of fluindapyr is about 28 g/L.

In a preferred embodiment, the concentration of fluindapyr is about 19 g/L.

According to an embodiment, the concentration of bixafen ranges from about 1 g/L to about 50 g/L.

In a preferred embodiment, the concentration of bixafen is about 30 g/L.

According to an embodiment of the present invention, the stable agrochemical composition comprises at least one additional fungicide.

According to an embodiment of the present invention, the stable agrochemical composition comprises an additional fungicide selected from the group comprising dithiocarbamate, azole, benzimidazole, strobilurin, copper, copper compounds, sulphur, sulphur compounds, or derivatives thereof.

According to an embodiment of the present invention, the stable agrochemical composition comprises an additional fungicide selected from the group comprising dithiocarbamate, azole, benzimidazole, strobilurin, copper, copper compounds, or derivatives thereof.

According to an embodiment of the present invention, the stable agrochemical composition comprises a dithiocarbamate fungicide.

According to an embodiment of the present invention, the stable agrochemical composition comprises a dithiocarbamate fungicide selected from the group comprising azithiram, manam, thiram, ziram, dazomet, mancopper, mancozeb, maneb, metiram, propineb and zineb.

According to an embodiment of the present invention, the dithiocarbamate fungicide is mancozeb.

According to an embodiment of the present invention, the stable agrochemical composition comprises a azole fungicide.

According to an embodiment of the present invention, the stable agrochemical composition comprises an azole fungicide selected from the group comprising azaconazole, bromuconazole, cyproconazole, diclobutrazol, difenoconazole, epoxiconazole, etaconazole, fenbuconazole, flusilazole, flutriafol, furconazole, hexaconazole, metconazole, myclobutanil, penconazole, propiconazole, prothioconazole, quinconazole, simeconazole, tebuconazole, tetraconazole, triticonazole and uniconazole.

According to an embodiment of the present invention, the azole fungicide is prothioconazole.

According to an embodiment of the present invention, the azole fungicide is tebuconazole.

According to an embodiment of the present invention, the azole fungicide is difenoconazole.

According to an embodiment of the present invention, the azole fungicide is hexaconazole.

According to an embodiment of the present invention, the stable agrochemical composition comprises a benzimidazole fungicide.

According to an embodiment of the present invention, the stable agrochemical composition comprises a benzimidazole fungicide selected from the group comprising albendazole, benomyl, carbendazim, chlorfenazole, cypendazole, dimefluazole, fuberidazole, and thiabendazole.

According to an embodiment of the present invention, the stable agrochemical composition comprises a strobilurin fungicide.

According to an embodiment of the present invention, the stable agrochemical composition comprises a strobilurin fungicide selected from the group comprising azoxystrobin, fluoxastrobin, picoxystrobin, pyraoxystrobin, pyraclostrobin, pyrametostrobin, fenaminstrobin, metominostrobin, kresoxim-methyl, and trifloxystrobin.

According to an embodiment of the present invention, the stable agrochemical composition comprises a copper and copper compound fungicide.

According to an embodiment of the present invention, the stable agrochemical composition comprises a copper and copper compound fungicide selected from the group comprising basic copper carbonate, basic copper sulfate, tribasic copper sulphate, copper glycinate, Bordeaux mixture, copper hydroxide, copper oxychloride, copper sulfate, cuprous oxide, and mancopper.

In a preferred embodiment, said additional fungicide is selected from the group comprising azoxystrobin, trifloxystrobin, fluoxastrobin, pyraclostrobin, prothioconazole, tebuconazole, ipconazole, penconazole, mancozeb, maneb, zineb, copper, basic copper sulfate, tribasic copper sulphate, bordeaux mixture, copper hydroxide, copper oxychloride, cuprous oxide, mancopper, or derivatives thereof.

According to an embodiment of the present invention, the stable agrochemical composition comprises from about 0.1% w/w to about 90% w/w additional fungicide of total weight of the composition.

According to an embodiment of the present invention, the stable agrochemical composition comprises from about 0.5% w/w to about 90% w/w additional fungicide of total weight of the composition.

According to an embodiment of the present invention, the stable agrochemical composition comprises from about 1% w/w to about 90% w/w additional fungicide of total weight of the composition.

According to an embodiment of the present invention, the stable agrochemical composition comprises from about 10% w/w to about 90% w/w additional fungicide of total weight of the composition.

According to an embodiment of the present invention, the agrochemical composition comprises from about 1% w/w to about 80% w/w dithiocarbamate fungicide of total weight of the composition.

According to an embodiment of the present invention, the agrochemical composition comprises from about 10% w/w to about 60% w/w mancozeb of total weight of the composition.

In a preferred embodiment, the agrochemical composition comprises about 41.2% w/w mancozeb of total weight of the composition.

In a preferred embodiment, the agrochemical composition comprises about 35.5% w/w mancozeb of total weight of the composition.

According to an embodiment, the concentration of mancozeb ranges from about 100 g/L to about 600 g/L.

In an embodiment, the concentration of mancozeb ranges from about 200 g/L to about 500 g/L.

In a preferred embodiment, the concentration of mancozeb is about 450 g/L.

In a preferred embodiment, the concentration of mancozeb is about 400 g/L.

According to an embodiment of the present invention, the agrochemical composition comprises from about 1% w/w to about 80% w/w azole fungicide of total weight of the composition.

According to an embodiment of the present invention, the agrochemical composition comprises from about 1% w/w to about 30% w/w prothioconazole of total weight of the composition.

In a preferred embodiment, the agrochemical composition comprises about 2.60% w/w prothioconazole of total weight of the composition.

In a preferred embodiment, the agrochemical composition comprises about 1.60% w/w prothioconazole of total weight of the composition.

According to an embodiment, the concentration of prothioconazole ranges from about 1 g/L to about 60 g/L.

In an embodiment, the concentration of prothioconazole ranges from about 1 g/L to about 50 g/L.

In a preferred embodiment, the concentration of prothioconazole is about 30 g/L.

In a preferred embodiment, the concentration of prothioconazole is about 19 g/L.

According to an embodiment of the present invention, the agrochemical composition comprises from about 1% w/w to about 30% w/w tebuconazole of total weight of the composition.

In a preferred embodiment, the agrochemical composition comprises about 3.20% w/w tebuconazole of total weight of the composition.

In a preferred embodiment, the agrochemical composition comprises about 2.20% w/w tebuconazole of total weight of the composition.

According to an embodiment, the concentration of tebuconazole ranges from about 1 g/L to about 60 g/L.

In an embodiment, the concentration of tebuconazole ranges from about 1 g/L to about 50 g/L.

In a preferred embodiment, the concentration of tebuconazole is about 40 g/L.

In a preferred embodiment, the concentration of tebuconazole is about 27 g/L.

According to an embodiment of the present invention, the stable agrochemical composition comprises an unsaturated lipid.

According to an embodiment of the present invention, the unsaturated lipid comprises esters of fatty acids with glycerol.

According to an embodiment of the present invention, the stable agrochemical composition comprises an unsaturated lipid obtained from any suitable source.

According to an embodiment of the present invention, the stable agrochemical composition comprises an unsaturated lipid obtained from any suitable source of plant or animal origin.

According to an embodiment of the present invention, the esters of fatty acids with glycerol are selected from the group comprising plant oil, vegetable oil, modified plant oil, modified vegetable oil, oil having animal origin, or combinations thereof.

In a preferred embodiment, the unsaturated lipid comprises esters of fatty acids with glycerol selected from the group comprising plant oil, vegetable oil, modified plant oil, modified vegetable oil, or combinations thereof.

According to an embodiment of the present invention, the unsaturated lipid is selected from vegetable oils, which are generally known and commercially available. The term “vegetable oils” is to be understood as including but not limited to, oils from oleaginous plant species, such as soyabean oil (or soybean oil), rapeseed oil, maize germ oil, maize kernel oil, sunflower oil, cottonseed oil, linseed oil, coconut oil, palm oil, thistle oil, walnut oil, arachis oil, olive oil, canola oil or castor oil, colza oil, or mixtures thereof.

In a preferred embodiment, the unsaturated lipid is selected from vegetable oils comprising soyabean oil, rapeseed oil, maize germ oil, canola oil, sunflower oil, or mixtures thereof.

According to an embodiment of the present invention, the unsaturated lipid comprises a modified vegetable oil obtained by trans-esterifying vegetable oils with short-chain alcohols, such as methanol, ethanol, butanol and pentanol, or by esterifying fatty acid fractions derived from the saponification of vegetable oils with the aforesaid alcohols.

The unsaturated lipid is selected from the group comprising soy methyl ester (methyl soyate), rapeseed methyl ester, palm methyl ester, palm kernel methyl ester, coconut methyl ester, C₈₋₁₀ methyl ester, or combinations thereof.

In a preferred embodiment, the unsaturated lipid selected from the group comprising soya bean oil, rapeseed oil, maize germ oil, maize kernel oil, sunflower oil, cottonseed oil, linseed oil, coconut oil, palm oil, canola oil, castor oil, soy methyl ester, rapeseed methyl ester, palm methyl ester, palm kernel methyl ester, coconut methyl ester, C₈₋₁₀ methyl ester, or combinations thereof.

According to an embodiment of the present invention, the stable agrochemical composition comprises from about 0.1% w/w to about 25% w/w unsaturated lipid or a derivative thereof of total weight of the composition.

In another embodiment of the present invention, the stable agrochemical composition comprises from about 0.5% w/w to about 20% w/w unsaturated lipid or a derivative of total weight of the composition.

In another embodiment of the present invention, the stable agrochemical composition comprises from about 1% w/w to about 15% w/w unsaturated lipid or a derivative of total weight of the composition.

According to an embodiment of the present invention, the stable agrochemical composition comprises an additive.

According to an embodiment of the present invention, the additive is selected from the group comprising clay, modified clay, high surface area silica, starch derivatives, cellulose derivatives, or mixtures thereof.

According to an embodiment of the present invention, the additive comprises clay and modified clay, which comprise treated and untreated clays selected from the group comprising kaolin, China clay and bentonite clays, which may be natural bentonites or modified bentonites.

According to an embodiment of the present invention, the additive comprises high surface area silica selected from the group comprising synthetic and diatomaceous silicas, calcium and magnesium silicates, titanium dioxide, aluminium, calcium or magnesium carbonate, ammonium sulfate, sodium sulfate, potassium sulfate, calcium sulfate, barium sulfate, charcoal, or combinations thereof.

According to an embodiment of the present invention, the additive comprises starch derivatives comprising modified starches such as alkyl and carboxyalkyl starches and mixtures.

According to an embodiment of the present invention, the additive comprises cellulose derivatives comprising modified cellulose such as powdered microcrystalline cellulose (MCC), microcrystalline cellulose, and colloidal MCC.

According to an embodiment of the present invention, the additive is selected from the group comprising diatomaceous silicas, calcium and magnesium silicates, titanium dioxide, aluminium, calcium or magnesium carbonate, ammonium sulfate, sodium sulfate, starch, carboxyalkyl starch, cellulose, powdered microcrystalline cellulose (MCC), microcrystalline cellulose, colloidal MCC, or combinations thereof.

In a preferred embodiment, the additive is selected from the group comprising clay, modified clay, high surface area silica, starch, modified starch, cellulose, modified cellulose, or mixtures thereof.

According to an embodiment of the present invention, the stable agrochemical composition comprises from about 0.01% w/w to about 10% w/w additive of total weight of the composition.

According to an embodiment of the present invention, the stable agrochemical composition comprises from about 0.1% w/w to about 10% w/w additive of total weight of the composition.

According to an embodiment of the present invention, the stable agrochemical composition comprises from about 0.5% w/w to about 5% w/w additive of total weight of the composition.

According to an embodiment of the present invention, the stable agrochemical composition is present in a form of a suspension concentrate (SC).

According to an embodiment of the present invention, the stable agrochemical composition comprises:
(a) at least one pyrazolecarboxamide fungicide or a derivative thereof;
(b) at least one additional fungicide selected from the group comprising dithiocarbamate, azole, benzimidazole, strobilurin, copper, copper compound, or derivatives thereof;
(c) an unsaturated lipid or a derivative thereof; and
(d) an additive.

According to an embodiment of the present invention, the stable agrochemical composition comprises:
(a) fluindapyr;
(b) at least one additional fungicide selected from the group comprising azoxystrobin, trifloxystrobin, fluoxastrobin, pyraclostrobin, prothioconazole, tebuconazole, ipconazole, penconazole, mancozeb, maneb, zineb, copper, basic copper sulfate, tribasic copper sulphate, bordeaux mixture, copper hydroxide, copper oxychloride, cuprous oxide, mancopper, or combinations thereof;
(c) an unsaturated lipid or a derivative thereof selected from the group comprising vegetable oil, plant oil, seed oil, modified plant and vegetable oil, oil having animal origin, or combinations thereof; and
(d) an additive selected from the group comprising clay, modified clay, high surface area silica, starch, modified starch, cellulose, modified cellulose, or mixtures thereof.

According to an embodiment of the present invention, the stable agrochemical composition comprises:
(a) fluindapyr;
(b) at least one additional fungicide selected from the group comprising azoxystrobin, trifloxystrobin, fluoxastrobin, pyraclostrobin, prothioconazole, tebuconazole, ipconazole, penconazole, mancozeb, maneb, zineb, copper, basic copper sulfate, tribasic copper sulphate, bordeaux mixture, copper hydroxide, copper oxychloride, cuprous oxide, mancopper, or combinations thereof;
(c) an unsaturated lipid or a derivative thereof selected from the group comprising vegetable oil, plant oil, seed oil, modified plant and vegetable oil, oil having animal origin, or combinations thereof; and
(d) an additive selected from the group comprising clay, modified clay, high surface area silica, starch, modified starch, cellulose, modified cellulose, or mixtures thereof;
wherein said composition is present in a form of a suspension concentrate (SC).

According to an embodiment of the present invention, the stable agrochemical composition comprises:
(a) fluindapyr;
(b) mancozeb;
(c) at least one additional fungicide selected from prothioconazole, tebuconazole, or combinations thereof;
(d) an unsaturated lipid or a derivative thereof selected from the group comprising vegetable oil, plant oil, seed oil, modified plant and vegetable oil, oil having animal origin, or combinations thereof; and
(e) an additive selected from the group comprising clay, modified clay, starch, modified starch, cellulose, modified cellulose, or mixtures thereof.

According to an embodiment of the present invention, the stable agrochemical composition comprises:
(a) fluindapyr;
(b) mancozeb and prothioconazole;
(c) an unsaturated lipid or a derivative thereof selected from the group comprising vegetable oil, plant oil, seed oil, modified plant and vegetable oil, oil having animal origin, or combinations thereof; and
(d) an additive selected from the group comprising clay, modified clay, starch, modified starch, cellulose, modified cellulose, or mixtures thereof.

According to an embodiment of the present invention, the stable agrochemical composition comprises:
(a) fluindapyr;
(b) mancozeb and tebuconazole;
(c) an unsaturated lipid or a derivative thereof selected from the group comprising vegetable oil, plant oil, seed oil, modified plant and vegetable oil, oil having animal origin, or combinations thereof; and
(d) an additive selected from the group comprising clay, modified clay, starch, modified starch, cellulose, modified cellulose, or mixtures thereof.

According to an embodiment of the present invention, the stable agrochemical composition comprises:
(a) fluindapyr;
(b) mancozeb, prothioconazole and tebuconazole;
(c) an unsaturated lipid or a derivative thereof selected from the group comprising vegetable oil, plant oil, seed oil, modified plant and vegetable oil, oil having animal origin, or combinations thereof; and
(d) an additive selected from the group comprising clay, modified clay, starch, modified starch, cellulose, modified cellulose, or mixtures thereof.

According to an embodiment of the present invention, the stable agrochemical composition comprises:
(a) bixafen;
(b) at least one additional fungicide selected from the group comprising azoxystrobin, trifloxystrobin, fluoxastrobin, pyraclostrobin, prothioconazole, tebuconazole, ipconazole, penconazole, mancozeb, maneb, zineb, copper, basic copper sulfate, tribasic copper sulphate, bordeaux mixture, copper hydroxide, copper oxychloride, cuprous oxide, mancopper, or combinations thereof;
(c) an unsaturated lipid or a derivative thereof selected from the group comprising vegetable oil, plant oil, seed oil, modified plant and vegetable oil, oil having animal origin, or combinations thereof; and
(d) an additive selected from the group comprising clay, modified clay, high surface area silica, starch, modified starch, cellulose, modified cellulose, or mixtures thereof.

According to an embodiment of the present invention, the stable agrochemical composition comprises:
(a) bixafen;
(b) at least one additional fungicide selected from the group comprising azoxystrobin, trifloxystrobin, fluoxastrobin, pyraclostrobin, prothioconazole, tebuconazole, ipconazole, penconazole, mancozeb, maneb, zineb, copper, basic copper sulfate, tribasic copper sulphate, bordeaux mixture, copper hydroxide, copper oxychloride, cuprous oxide, mancopper or combinations thereof;
(c) an unsaturated lipid or a derivative thereof selected from the group comprising vegetable oil, plant oil, seed oil, modified plant and vegetable oil, oil having animal origin, or combinations thereof; and
(d) an additive selected from the group comprising clay, modified clay, high surface area silica, starch, modified starch, cellulose, modified cellulose, or mixtures thereof;
wherein said composition is present in a form of suspension concentrate.

According to an embodiment of the present invention, the stable agrochemical composition comprises:
(a) bixafen;
(b) mancozeb;
(c) at least one additional fungicide selected from prothioconazole, tebuconazole, or combinations thereof;
(d) an unsaturated lipid or a derivative thereof selected from the group comprising vegetable oil, plant oil, seed oil, modified plant and vegetable oil, oil having animal origin, or combinations thereof; and
(e) an additive selected from the group comprising clay, modified clay, starch, modified starch, cellulose, modified cellulose, or mixtures thereof.

According to an embodiment of the present invention, the stable agrochemical composition comprises:
(a) bixafen;
(b) mancozeb and prothioconazole;
(c) an unsaturated lipid or a derivative thereof selected from the group comprising vegetable oil, plant oil, seed oil, modified plant and vegetable oil, oil having animal origin, or combinations thereof; and
(d) an additive selected from the group comprising clay, modified clay, starch, modified starch, cellulose, modified cellulose, or mixtures thereof.

According to an embodiment of the present invention, the stable agrochemical composition comprises:
(a) bixafen;
(b) mancozeb and tebuconazole;
(c) an unsaturated lipid or a derivative thereof selected from the group comprising vegetable oil, plant oil, seed oil, modified plant and vegetable oil, oil having animal origin, or combinations thereof; and
(d) an additive selected from the group comprising clay, modified clay, starch, modified starch, cellulose, modified cellulose, or mixtures thereof.

According to an embodiment of the present invention, the stable agrochemical composition comprises:
(a) bixafen;
(b) mancozeb, prothioconazole and tebuconazole;
(c) an unsaturated lipid or a derivative thereof selected from the group comprising vegetable oil, plant oil, seed oil, modified plant and vegetable oil, oil having animal origin, or combinations thereof; and
(d) an additive selected from the group comprising clay, modified clay, starch, modified starch, cellulose, modified cellulose, or mixtures thereof.

According to an embodiment of the present invention, the stable agrochemical composition comprises:
(a) at least one pyrazolecarboxamide fungicide or a derivative thereof;
(b) at least one additional fungicide selected from the group comprising dithiocarbamate, azole, benzimidazole, strobilurin, copper, copper compound, or derivatives thereof;
(c) an unsaturated lipid or a derivative thereof;
(d) an additive; and
(e) optionally at least one agrochemically acceptable excipient.

According to an embodiment of the present invention, the stable agrochemical composition comprises:
(a) at least one pyrazolecarboxamide fungicide selected from fluindapyr or bixafen;
(b) at least one additional fungicide selected from dithiocarbamate fungicide or azole fungicide;
(c) an unsaturated lipid or a derivative thereof;
(d) an additive; and
(e) optionally at least one agrochemically acceptable excipient.

According to an embodiment of the present invention, the stable agrochemical composition comprises:
(a) at least one pyrazolecarboxamide fungicide selected from fluindapyr or bixafen;
(b) at least one additional fungicide selected from mancozeb, prothioconazole or tebuconazole;
(c) an unsaturated lipid or a derivative thereof;
(d) an additive; and
(e) optionally at least one agrochemically acceptable excipient.

According to an embodiment of the present invention, the stable agrochemical composition comprises at least one agrochemically acceptable excipient.

In an embodiment, the agrochemically acceptable excipient is any or a combination of surfactant(s), preservative(s), coloring agent(s), pH adjusting agent(s), anti-foaming agent(s) solvent(s), inactive ingredients(s)/binder(s), disintegrant(s), lubricant(s), wetting agent(s), dispersing agent(s), binding agent(s), anti-freezing agent(s), mineral(s), filler(s), or combinations thereof. However, it should be appreciated that any other agrochemically acceptable excipients, as known to a person skilled in the art, may be used to serve its intended purpose.

According to an embodiment of the present disclosure, the surfactant may include any or a combination of ionic surfactants and non-ionic surfactants. Non-limiting examples of ionic surfactants include sulfonic acids, sulfuric acid esters, carboxylic acids, and salts thereof. Non-limiting examples of water soluble anionic surfactants include alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyltaurates, and alkyl carboxylates. Non-limiting examples of the non-ionic surfactants include glycerol ethers, glycol ethers, ethanolamides, sulfoanylamides, alcohols, amides, alcohol ethoxylates, glycerol esters, glycol esters, ethoxylates of glycerol ester and glycol esters, sugar-based alkyl polyglycosides, polyoxyethylenated fatty acids, alkanolamine condensates, alkanolamides, tertiary acetylenic glycols, polyoxyethylenated mercaptans, carboxylic acid esters, polyoxyethylenated polyoxyproylene glycols, sorbitan fatty esters, or combinations thereof. Also included are EO/PO block copolymers (EO is ethylene oxide, PO is propylene oxide), EO polymers and copolymers, polyamines, and polyvinylpynolidones, sorbitan fatty acid alcohol ethoxylates and sorbitan fatty acid ester ethoxylates.

In another embodiment, suitable preservative(s) are for example benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl, benzoic acid, or combinations thereof.

In an embodiment, the coloring agent(s) may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc.

According to an embodiment, antifoaming agent(s) may be selected from polydimethoxysiloxane, polydimethylsiloxane, emulsion of polysiloxane, alkyl poly acrylates, castor oil, fatty acids, fatty acids esters, fatty acids sulfate, fatty alcohol, fatty alcohol esters, fatty alcohol sulfate, foot olive oil, mono & di glyceride, paraffin oil, paraffin wax, silicone, silicone oil, vegetable fats, vegetable fats sulfate, vegetable wax, vegetable wax sulfate, agents based on silicon or magnesium stearate, and blend of maltodextrin, and methylated silica.

According to an embodiment, examples of suitable solvent(s) are water, oils of vegetable, or derivatives. In principle, solvent mixtures may also be used.

According to an embodiment, the stable agrochemical composition comprises inactive ingredient(s) or binder(s). A wide variety of binders can be used, like for example lactose powder, dibasic calcium phosphate, sucrose, corn (maize) starch, microcrystalline cellulose or modified cellulose, like for example hydroxymethyl cellulose.

According to an embodiment, the stable agrochemical composition may also contain an ingredient that can act as a disintegrant(s), which hydrates readily in water and thereby improves the dispersion of the composition in water. Some of the above-mentioned binders, like for example starch and cellulose, can also be used as a disintegrant.

According to an embodiment, the commonly used lubricant(s) are for example magnesium stearate, stearic acid (stearine), hydrogenated oil and sodium stearyl fumarate.

According to an embodiment, the wetting agent(s) may include any or a combination of sulfosuccinates, naphthalene sulfonates, sulfated esters, phosphate esters, sulfated alcohol and alkyl benzene sulfonates, but not limited thereto.

According to an embodiment, the dispersing agent(s) may include any or a combination of polycarboxylates, naphthalene sulfonate condensates, phenol sulfonic acid condensates, lignosulfonates, methyl oleyl taurates and polyvinyl alcohols, but not limited thereto.

According to an embodiment, the binding agent(s) may include any or a combination of polyvinyl alcohols, phenyl naphthalene sulphonate, lignin derivatives, polyvinyl pyrrolidone, polyalkylpyrrolidone, carboxymethylcellulose, xanthan gum, polyethoxylated fatty acids, polyethoxylated fatty alcohols, ethylene oxide copolymer, propylene oxide copolymer, polyethylene glycols and polyethylene oxides, but not limited thereto.

According to an embodiment, the anti-freezing agent(s) may include any or a combination of ethylene glycol, propylene glycol, urea, glycerin and anti-freeze proteins, but not limited thereto.

According to an embodiment, the mineral(s) may include any or a combination of kaolin, silica, titanium (IV) oxide, rutile, anatase, aluminum oxides, aluminum hydroxides, iron oxide, iron sulfide, magnetite, pyrite, hematite, ferrite, gregite, calcium carbonate, calcite, aragonite, quartz, zircon, olivine, orthopyroxene, tourmaline, kyanite, albite, anorthite, clinopyroxene, orthoclase, gypsum, andalusite, talc, fluorite, apatite, orthoclase, topaz, corundum, diamond, tin, tin oxides, antimony, antimony oxides, beryllium, cobalt, copper, feldspar, gallium, indium, lead, lithium, manganese, mica, molybdenum, nickel, perlite, platinum group metals, phosphorus and phosphate rock, potash, rare earth elements, tantalum, tungsten, vanadium, zeolites, zinc and zinc oxide, and indium tin oxide, but not limited thereto.

According to an embodiment, the filler(s) may include any or a combination of diatomaceous earth, kaolin, bentonite, precipitated silica, attapulgite, and perlite, but not limited thereto.

In an embodiment, the composition further comprises at least one selected from the group comprising fertilizers, mycorrhiza, micronutrients, acaricides, algicides, antifeedants, avicides, bactericides, bird repellents, chemosterilants, fungicides, herbicide safeners, herbicides, insect attractants, insect repellents, insecticides, mammal repellents, mating disruptors, molluscicides, nematicides, plant activators, plant-growth regulators, rodenticides, synergists, virucides, derivatives thereof, biological control agents, and mixtures thereof.

In an embodiment, the agrochemically acceptable excipients are present in an amount ranging from about 0.1% w/w to about 99% w/w of total weight of the composition.

In a preferred embodiment, the agrochemically acceptable excipients are present in an amount ranging from about 0.1% w/w to about 50% w/w of total weight of the composition.

According to an embodiment, the agrochemical compositions of the present disclosure can be formulated as liquid formulations (e.g., soluble concentrate, suspension concentrate, emulsifiable concentrate, flowable concentrate, flowable suspension, etc.) and the likes as known to persons skilled in the art.

In another embodiment, the agrochemical composition is present in a form of a liquid composition.

In another embodiment, the liquid agrochemical composition is present in a form of suspension concentrate (SC).

In a preferred embodiment, the agrochemical composition is present in a form of suspension concentrate (SC).

According to an embodiment of the present invention, a suspension concentrate comprising:
(a) fluindapyr or bixafen;
(b) at least one additional fungicide selected from the group comprising azoxystrobin, trifloxystrobin, fluoxastrobin, pyraclostrobin, prothioconazole, tebuconazole, ipconazole, penconazole, mancozeb, maneb, zineb, copper, basic copper sulfate, tribasic copper sulphate, bordeaux mixture, copper hydroxide, copper oxychloride, cuprous oxide, mancopper, or derivatives thereof;
(c) an unsaturated lipid or a derivative thereof; and
(d) an additive selected from the group comprising clay, modified clay, high surface area silica, starch, modified starch, cellulose, modified cellulose, or mixtures thereof.

According to an embodiment of the present invention, the suspension concentrate composition comprises (a) fluindapyr, (b) at least one additional fungicide, (c) an unsaturated lipid or a derivative thereof, and (d) an additive.

According to an embodiment of the present invention, the suspension concentrate composition comprises:
(a) fluindapyr;
(b) at least one additional fungicide selected from mancozeb, prothioconazole, tebuconazole, or combinations thereof;
(c) soy methyl ester, and
(d) modified cellulose.

According to an embodiment of the present invention, the suspension concentrate composition comprises:
(a) fluindapyr;
(b) mancozeb;
(c) at least one additional fungicide selected from prothioconazole, tebuconazole, or combinations thereof;
(d) soy methyl ester, and
(e) modified cellulose.

According to an embodiment of the present invention, the suspension concentrate composition comprises (a) fluindapyr, (b) mancozeb and prothioconazole, (c) soy methyl ester, and (d) microcrystalline cellulose.

According to an embodiment of the present invention, the suspension concentrate composition comprises (a) fluindapyr, (b) mancozeb and tebuconazole, (c) soy methyl ester, and (d) microcrystalline cellulose.

According to an embodiment of the present invention, the suspension concentrate composition comprises (a) fluindapyr, (b) mancozeb, prothioconazole and tebuconazole, (c) soy methyl ester, and (d) microcrystalline cellulose.

According to an embodiment of the present invention, the suspension concentrate composition comprises (a) bixafen, (b) at least one additional fungicide, (c) an unsaturated lipid or a derivative thereof, and (d) an additive.

According to an embodiment of the present invention, the suspension concentrate composition comprises:
(a) bixafen;
(b) at least one additional fungicide selected from mancozeb, prothioconazole, tebuconazole, or combinations thereof;
(c) vegetable oil, and
(d) modified cellulose.

According to an embodiment of the present invention, the suspension concentrate composition comprises:
(a) bixafen;
(b) mancozeb;
(c) at least one additional fungicide selected from prothioconazole, tebuconazole, or combinations thereof;
(d) vegetable oil, and
(e) modified cellulose.

According to an embodiment of the present invention, the suspension concentrate composition comprises (a) bixafen, (b) mancozeb and prothioconazole, (c) vegetable oil, and (d) microcrystalline cellulose.

According to an embodiment of the present invention, the suspension concentrate composition comprises (a) bixafen, (b) mancozeb and tebuconazole, (c) vegetable oil, and (d) microcrystalline cellulose.

According to an embodiment of the present invention, the suspension concentrate composition comprises (a) bixafen, (b) mancozeb, prothioconazole and tebuconazole, (c) vegetable oil, and (d) microcrystalline cellulose.

According to an embodiment, the present invention provides a process of preparing the stable agrochemical composition.

According to an embodiment of the present invention, a process of preparing a stable agrochemical composition, said process comprising:
(a) mixing, and optionally blending and milling, at least one pyrazolecarboxamide fungicide, at least one additional fungicide, an unsaturated lipid, an additive, and water to obtain a mixture;
(b) adding to the mixture of step (a), a separately prepared gel to obtain the stable agrochemical composition.

According to an embodiment of the present invention, a process of preparing a stable agrochemical composition, said process comprising:
(a) mixing, blending and milling at least one pyrazolecarboxamide fungicide, at least one additional fungicide, an unsaturated lipid, an additive, and water to obtain a mixture;
(b) adding to the mixture of step (a), a separately prepared gel to obtain the stable agrochemical composition.

According to an embodiment of the present invention, a process of preparing a stable suspension concentrate agrochemical composition, said process comprising:
(a) preparing a slurry by adding at least one pyrazolecarboxamide fungicide or a derivative thereof, at least one additional fungicide or a derivative thereof, an unsaturated lipid or a derivative thereof, an additive and optionally other excipients in water;
(b) milling the slurry of step (a) to achieve a desired particle size;
(c) separately, preparing a gel by adding a thickener and a biocide in water; and
(d) adding the gel of step (c) to the slurry of step (b) to obtain the suspension concentrate agrochemical composition.

According to an embodiment of the present invention, a process of preparing a stable suspension concentrate agrochemical composition, said process comprising:
(a) mixing, and optionally blending and milling, a pyrazolecarboxamide fungicide wherein said pyrazolecarboxamide fungicide is fluindapyr; at least one additional fungicide selected from prothioconazole, tebuconazole, mancozeb, azoxystrobin, copper, or copper compounds; an unsaturated lipid; an additive; and water to obtain a mixture;
(b) milling the mixture of step (a) to obtain a slurry with a desired particle size;
(c) separately, preparing a gel by adding a thickener and a biocide in water; and
(d) adding the gel of step (c) to the slurry of step (b) to obtain the suspension concentrate agrochemical composition.

According to an embodiment of the present invention, a process of preparing a stable suspension concentrate agrochemical composition, said process comprising:
(a) mixing, blending and milling a pyrazolecarboxamide fungicide wherein said pyrazolecarboxamide fungicide is fluindapyr; at least one additional fungicide selected from prothioconazole, tebuconazole, mancozeb, azoxystrobin, copper, or copper compounds; an unsaturated lipid; an additive; and water to obtain a mixture;
(b) milling the mixture of step (a) to obtain a slurry with a desired particle size;
(c) separately, preparing a gel by adding a thickener and a biocide in water; and
(d) adding the gel of step (c) to the slurry of step (b) to obtain the suspension concentrate agrochemical composition.

According to an embodiment of the present invention, a process of preparing a stable suspension concentrate agrochemical composition, said process comprising:
(a) preparing a slurry by adding a) fluindapyr, b) at least one additional fungicide selected from prothioconazole, tebuconazole, mancozeb, azoxystrobin, copper, or copper compounds; c) soy methyl ester, d) microcrystalline cellulose and optionally other excipients in water;
(b) milling the slurry of step (a) to achieve a desired particle size;
(c) separately, preparing a gel by adding a thickener and a biocide in water; and
(d) adding the gel of step (c) to the slurry of step (b) to obtain the suspension concentrate agrochemical composition.

According to an embodiment of the present invention, a process of preparing a stable suspension concentrate agrochemical composition, said process comprising:
(a) mixing, and optionally blending and milling, a pyrazolecarboxamide fungicide wherein said pyrazolecarboxamide fungicide is bixafen; at least one additional fungicide selected from prothioconazole, tebuconazole, mancozeb, azoxystrobin, copper, or copper compound; an unsaturated lipid; an additive; and water to obtain a mixture;
(b) milling the mixture of step (a) to obtain a slurry with a desired particle size;
(c) separately, preparing a gel by adding a thickener and a biocide in water; and
(d) adding the gel of step (c) to the slurry of step (b) to obtain the suspension concentrate agrochemical composition.

According to an embodiment of the present invention, a process of preparing a stable suspension concentrate agrochemical composition, said process comprising:
(a) mixing, blending and milling a pyrazolecarboxamide fungicide wherein said pyrazolecarboxamide fungicide is bixafen; at least one additional fungicide selected from prothioconazole, tebuconazole, mancozeb, azoxystrobin, copper, or copper compound; an unsaturated lipid; an additive; and water to obtain a mixture;
(b) milling the mixture of step (a) to obtain a slurry with a desired particle size;
(c) separately, preparing a gel by adding a thickener and a biocide in water; and
(d) adding the gel of step (c) to the slurry of step (b) to obtain the suspension concentrate agrochemical composition.

According to an embodiment of the present invention, a process of preparing a stable suspension concentrate agrochemical composition, said process comprising:
(a) preparing a slurry by adding a) bixafen, b) at least one additional fungicide selected from prothioconazole, tebuconazole, mancozeb, azoxystrobin, copper, or copper compounds; c) vegetable oil, d) microcrystalline cellulose and optionally other excipients in water;
(b) milling the slurry of step (a) to achieve a desired particle size;
(c) separately, preparing a gel by adding a thickener and a biocide in water; and
(d) adding the gel of step (c) to the slurry of step (b) to obtain the suspension concentrate agrochemical composition.

According to an embodiment of the present invention, a process of preparing a stable suspension concentrate agrochemical composition, said process comprising:
(a) mixing, and optionally blending, fluindapyr or bixafen; at least one additional fungicide selected from the group comprising prothioconazole, tebuconazole, mancozeb, azoxystrobin, copper, or copper compounds; an unsaturated lipid; additive; optionally other agrochemical acceptable excipients; and water to obtain a mixture;
(b) milling the mixture of step (a) to obtain a slurry with a desired particle size;
(c) separately, preparing a gel by adding a thickener and a biocide in water; and
(d) adding the gel of step (c) to the slurry of step (b) to obtain the agrochemical composition.

According to an embodiment of the present invention, a process of preparing a stable suspension concentrate agrochemical composition, said process comprising:
(a) mixing and blending fluindapyr or bixafen; at least one additional fungicide selected from the group comprising prothioconazole, tebuconazole, mancozeb, azoxystrobin, copper, or copper compounds; an unsaturated lipid; additive; optionally other agrochemical acceptable excipients; and water to obtain a mixture;
(b) milling the mixture of step (a) to obtain a slurry with a desired particle size;
(c) separately, preparing a gel by adding a thickener and a biocide in water; and
(d) adding the gel of step (c) to the slurry of step (b) to obtain the agrochemical composition.

In an embodiment of the present invention, the thickener comprises xanthan gum.

In an embodiment of the present invention, the order of addition and mixing of the agrochemical ingredients and/or excipients is not narrowly critical.

According to an embodiment of the present invention, when more than one fungicide is combined to obtain a suspension concentrate composition, the fungicides may be subjected to milling operation to reduce the particle size.

According to an embodiment of the present invention, when more than one fungicide is combined to obtain a suspension concentrate composition, the fungicides may be subjected to milling to obtain uniform particle size ranging from about 1 μm to about 50 μm.

According to an embodiment of the present invention, when more than one fungicide is combined to obtain suspension concentrate composition, the fungicides may be subjected to milling to obtain a uniform particle size ranging from about 1 μm to about 20 μm.

According to an embodiment, the particle size (D₅₀) of the agrochemical composition of the present invention ranges from about 1 μm to about 10 μm.

According to an embodiment, the particle size (D₉₀) of the agrochemical composition of the present invention ranges from about 5 μm to about 15 μm.

According to an embodiment of the present invention, the blend is obtained using a suitable blender such as ribbon blender, V-blender, high intensity low mixer, plough shear mixer, and kneader mixer.

According to an embodiment of the present invention, a blend of fluindapyr fungicide or a derivative thereof, at least one additional fungicide, an unsaturated lipid, an additive, and at least one agrochemical excipient(s) may be taken for milling.

In an embodiment, the grinding may be performed in a suitable device such as air jet mill, air classifier mill, hammer mill, and pin disc mill. Jet mills are shear or pulverizing machines in which the particles to be milled are accelerated by gas flows and pulverized by collision. There are a number of different types of jet mill designs, such as double counterflow (opposing jet) and spiral (pancake) fluid energy mills.

According to an embodiment of the present invention, the ingredients used in the process of preparing the composition may be in a finely divided form, preferably in an air-milled form.

In an embodiment of the present invention, the pH of the agrochemical composition is adjusted from about 4 to about 7.

According to an embodiment of the present invention, the viscosity of the agrochemical composition ranges from about 1000 centipoise (cP) to about 2000 centipoise (cP).

According to an embodiment of the present invention, there is provided a method of controlling phytopathogenic fungal diseases by applying to a plant or to locus thereof, an agrochemical composition comprising: (a) at least one pyrazolecarboxamide fungicide or a derivative thereof; (b) at least one additional fungicide or a derivative thereof; (c) an unsaturated lipid or a derivative thereof; and (d) an additive.

According to an embodiment of the present invention, there is provided a method of controlling phytopathogenic fungal diseases by applying to the plants or to their locus or to a plant propagation material thereof, a stable agrochemical composition comprising: (a) at least one pyrazolecarboxamide fungicide or a derivative thereof; (b) at least one additional fungicide or a derivative thereof; (c) an unsaturated lipid or a derivative thereof; and (d) an additive.

According to an embodiment of the present invention, there is provided a method of controlling phytopathogenic fungal diseases by applying to the plants or to their locus or to a plant propagation material thereof, a stable agrochemical composition comprising: (a) at least one pyrazolecarboxamide fungicide or a derivative thereof wherein said pyrazolecarboxamide fungicide is fluindapyr; (b) at least one additional fungicide selected from prothioconazole, tebuconazole, mancozeb, azoxystrobin, copper, or copper compounds; (c) an unsaturated lipid or a derivative thereof, and (d) an additive.

According to an embodiment of the present invention, there is provided a method of controlling phytopathogenic fungal diseases by applying to the plants or to their locus or to a plant propagation material thereof, a stable agrochemical composition comprising: (a) fluindapyr; (b) at least one additional fungicide selected from prothioconazole, tebuconazole, mancozeb, azoxystrobin, copper, or copper compounds; (c) an unsaturated lipid, and (d) an additive.

Another aspect of the present invention, there is provided a method of controlling phytopathogenic fungal diseases by applying to the plants or to their locus or to a plant propagation material thereof, a stable agrochemical composition comprising: (a) fluindapyr; (b) at least one additional fungicide selected from prothioconazole, tebuconazole, mancozeb, azoxystrobin, copper, or copper compounds; (c) soy methyl ester, and (d) microcrystalline cellulose.

According to an embodiment of the present invention, there is provided a method of controlling phytopathogenic fungal diseases by applying to the plants or to their locus or to a plant propagation material thereof, a stable agrochemical composition comprising: (a) at least one pyrazolecarboxamide fungicide or a derivative thereof wherein said pyrazolecarboxamide fungicide is bixafen; (b) at least one additional fungicide selected from prothioconazole, tebuconazole, mancozeb, azoxystrobin, copper, or copper compounds; (c) an unsaturated lipid, and (d) an additive.

According to an embodiment of the present invention, there is provided a method of controlling phytopathogenic fungal diseases by applying to the plants or to their locus or to a plant propagation material thereof, a stable agrochemical composition comprising: (a) bixafen; (b) at least one additional fungicide selected from prothioconazole, tebuconazole, mancozeb, azoxystrobin, copper, or copper compounds; (c) an unsaturated lipid, and (d) an additive.

Another aspect of the present invention, there is provided a method of controlling phytopathogenic fungal diseases by applying to the plants or to their locus or to a plant propagation material thereof, a stable agrochemical composition comprising: (a) bixafen; (b) at least one additional fungicide selected from prothioconazole, tebuconazole, mancozeb, azoxystrobin, copper, or copper compounds; (c) vegetable oil, and (d) microcrystalline cellulose.

Another aspect of the present invention, there is provided a method of controlling phytopathogenic fungal diseases by applying to the plants or locus or plant propagation material thereof, a stable agrochemical composition comprising: (a) at least one pyrazolecarboxamide fungicide selected from fluindapyr or bixafen; (b) at least one additional fungicide selected from the group comprising prothioconazole, tebuconazole, mancozeb, azoxystrobin, copper, or copper compounds; (c) an unsaturated lipid comprising esters of fatty acids with glycerol; and (d) an additive.

According to an embodiment of the present invention, the stable agrochemical composition is used to protect several varieties of fruits, vegetables, nuts and field crops against a wide spectrum of fungal infestations, including potato blight, tomato blight, leaf spot, scab (on apples and pears), and rust (on roses). It may also be used for preventing growth of fungicidal infection in cotton, potatoes, corn, safflower, sorghum, peanuts, tomatoes, flax, chilly, groundnut, cluster bean (Guar), pulses, cucurbits, cereals, ornamental plants including rose and marigold, fruits including apple and spices including cumin.

According to an embodiment of the present invention, the agrochemical composition exhibits a broad range of fungicide activity against a large number of target pathogens. Non-limiting examples of specific pathogens targeted by the fungicide composition include: Botrytis cinerea (i.e., Botrytis bunch rot, gray mold, Botrytis blight), Phomopsis viticola (i.e., Phomopsis cane and leaf spot), Phomopsis rachis, Phomopsis vaccinii (i.e., Phomopsis twig blight and canker), downy mildew, Sphaerotheca macularis (i.e., powdery mildew), Guignardia bidwellii (i.e., black rot), Monilinia vacinii-cormbosi (i.e., mummy berry), Phragmidium sp. (i.e., yellow rust), Drepanopeziza sp. (i.e., anthracnose), Kuehneola sp. (i.e., cane and leaf rust), Sphaerulina sp. (i.e., orange rust), Arthuriomyces sp. (i.e., powdery mildew), Mycosphaerella sp. (leaf spot), Colletotrichum acutatum (i.e., anthracnose fruit rot), Verticillium albo-atrum (i.e., Verticillium wilt), Phytophthora fragariae (i.e., red stele root rot), Dendrophoma obscurans (i.e., stem end rot, leaf blight), Phytophthora cactorum (i.e., leather rot), Diplocarpon earliana (i.e., leaf scorch), Godronia cassandrac (i.e., fusicoccum canker), Alternaria sp. (i.e., Alternaria fruit rot), Exobasidium vaccinii (i.e., red leaf disease), Microsphaera vaccinii (i.e., powdery mildew), Venturia inaegualis (i.e., apple scab), Gymnosporangium sp. (i.e., apple rust), Podosphaera leucotricha (i.e., apple powdery mildew), black rot of apple, blossom end rot of apple, blue mold of apple, brown rot of stone fruit, Rhizopus sp., Leucostoma cincta or Leucostoma persoonii (i.e., cytospora canker of stone fruits), white rot of apple, Monilinia fructicola (i.e., brown rot of stone fruit), Blumeriella jaapii (i.e., cherry leaf spot of stone fruit), sooty mold of pear, pear leafspot, pear leaf blight and fruit spot, Pythium ultimatum, Phytophthora infestans (late blight, potatoes), Aspergillus sp. (i.e., Aspergillus paraciticus), Apiosporina morbosa (i.e., black knot of stone fruit), Rhizoctonia solani (i.e., black scurf in potatoes, aerial blight, soybeans), Alternaria solani (early blight, potatoes), Sclerotium rolfsii (i.e., Sclerotium rot, sugar beets), Fusarium sp., Septoria sp. and white mold in soybeans and the like.

According to an embodiment of the present invention, the stable agrochemical composition is used as fungicide.

In a preferred embodiment, the agrochemical composition is used for controlling phytopathogenic fungal diseases.

According to an embodiment of the present invention, the stable agrochemical composition comprising fluindapyr or a derivative thereof, an unsaturated lipid or a derivative thereof, and an additive; is used as fungicide.

According to an embodiment of the present invention, the stable agrochemical composition comprising fluindapyr or a derivative thereof, one additional fungicide or a derivative thereof, an unsaturated lipid or a derivative thereof, and an additive; is used as fungicide.

According to an embodiment of the present invention, the stable agrochemical composition comprising fluindapyr, mancozeb, prothioconazole, an unsaturated lipid or a derivative thereof and an additive; is used as fungicide.

According to an embodiment of the present invention, the stable agrochemical composition comprising fluindapyr, mancozeb, tebuconazole, an unsaturated lipid or a derivative thereof and an additive; is used as fungicide.

According to an embodiment of the present invention, the stable agrochemical composition comprising fluindapyr, mancozeb, prothioconazole, tebuconazole, an unsaturated lipid or a derivative thereof and an additive; is used as fungicide.

According to an embodiment of the present invention, the stable agrochemical composition comprising bixafen or a derivative thereof, an unsaturated lipid or a derivative thereof, and an additive; is used as fungicide.

According to an embodiment of the present invention, the stable agrochemical composition comprising bixafen or a derivative thereof, one additional fungicide or a derivative thereof, an unsaturated lipid or a derivative thereof, and an additive; is used as fungicide.

According to an embodiment of the present invention, the stable agrochemical composition comprising bixafen, mancozeb, prothioconazole, an unsaturated lipid or a derivative thereof and an additive; is used as fungicide.

According to an embodiment of the present invention, the stable agrochemical composition comprising bixafen, mancozeb, tebuconazole, an unsaturated lipid or a derivative thereof and an additive; is used as fungicide.

According to an embodiment of the present invention, the stable agrochemical composition comprising bixafen, mancozeb, prothioconazole, tebuconazole, an unsaturated lipid or a derivative thereof and an additive; is used as fungicide.

According to an embodiment of the present invention, a kit of parts comprising the stable agrochemical composition is provided. The kit of parts of parts comprises a plurality of components, each of which components may include at least one of the ingredients of the stable agrochemical composition of the present invention.

According to an embodiment of the present invention, a kit of parts comprises:
(a) at least one pyrazolecarboxamide fungicide or a derivative thereof;
(b) at least one additional fungicide or a derivative thereof;
(c) an unsaturated lipid or a derivative thereof;
(d) an additive; and
(e) optionally an instruction manual for use.

According to an embodiment of the present invention, a kit of parts comprises:
(a) at least one pyrazolecarboxamide fungicide or a derivative thereof;
(b) at least one additional fungicide selected from dithiocarbamate, azole, benzimidazole, strobilurins, copper, copper compounds, or a derivative thereof; and
(c) an unsaturated lipid or a derivative thereof;
(d) an additive; and
(e) optionally an instruction manual for use.

According to an embodiment of the present invention, a kit of parts comprises:
(a) at least one pyrazolecarboxamide fungicide or a derivative thereof selected from fluindapyr or bixafen;
(b) at least one additional fungicide selected from dithiocarbamate fungicide or azole fungicide; and
(c) an unsaturated lipid or a derivative thereof;
(d) an additive; and
(e) optionally an instruction manual for use.

According to an embodiment of the present invention, a kit of parts comprises:
(a) at least one pyrazolecarboxamide fungicide or a derivative thereof selected from fluindapyr or bixafen;
(b) at least one additional fungicide selected from dithiocarbamate fungicide or azole fungicide;
(c) an unsaturated lipid or a derivative thereof;
(d) an additive;
(e) optionally at least on agrochemically acceptable excipient; and
(f) optionally an instruction manual for use.

In one embodiment of the present invention, the kit of parts may include one or more, including all, components that may be used to prepare the stable agrochemical composition. E.g., kit of parts may include pyrazolecarboxamide fungicide, additional fungicide, an unsaturated lipid and an additive. One or more of the components may already be combined or pre-formulated. In those embodiments where more than two components are provided in a kit of parts, the components may already be combined and as such are packaged in a single container such as a vial, bottle, can, pouch, bag or canister.

In view of the above, it will be seen that the several advantages of the disclosure are achieved, and other advantageous results attained. Although the present disclosure has been disclosed in full, it will be understood that numerous additional modifications and variations could be made thereto without departing from the scope of the disclosure. The embodiments may be combined together for better understanding of the disclosure, without departing from the scope of the disclosure.

In another embodiment, alternative or multiple embodiments of the disclosure disclosed herein are not to be construed as limitations. Each embodiment can be referred to and claimed individually or in any combination with other embodiments of the disclosure. One or more embodiments of the disclosure can be included in, or deleted from, the disclosure for reasons of convenience and/or patentability.

It will be understood that the specification and examples are illustrative but not limitative of the present invention and that other embodiments within the spirit and scope of the invention will suggest themselves to those skilled in the art. Other embodiments can be practiced that are also within the scope of the present invention. The following examples illustrate the invention, but by no means intend to limit the scope of the claims.

### EXAMPLES

### Example 1: Mancozeb 450 g/L+Prothioconazole 30 g/L+Fluindapyr 30 g/L (SC)

| Ingredients | Quantity (% w/w) |
|---|---|
| Mancozeb | 41.2 |
| Prothioconazole | 2.6 |
| Fluindapyr | 2.6 |
| Propylene Glycol | 4.0 |
| Sodium lignosulphonate | 4.2 |
| Microcrystalline cellulose | 1.50 |
| Vegetable oil | 5.00 |
| Polydimethylsiloxane emulsion | 0.20 |
| Xanthan gum | 0.10 |
| 1,2-Benzisothiazolin-3-one | 0.10 |
| Water | Q.S. |
| Total | 100.00 |

### Process:

Fluindapyr, prothioconazole, propylene glycol, about 70% of total quantity of sodium lignosulphonate (dispersing agent) and polydimethylsiloxane emulsion (antifoaming agent) were charged in a vessel along with sufficient quantity of water and stirred to make a homogeneous solution followed by milling to obtain a slurry of a desired particle size. Separately, oil was mixed with water and remaining dispersing agents under vigorous stirring to obtain an emulsified oil. To the slurry, the emulsified oil and microcrystalline cellulose were added to obtain a mill base. Mancozeb was added to the mill base under continuous stirring followed by jellification by adding xanthan gum and 1,2-Benzisothiazolin-3-one (biocide) to obtain the suspension concentrate composition.

### Physico-Chemical Characteristics of the Composition of Example-1

The physico-chemical characteristics of the composition of Example-1 were studied to evaluate stability of the resulting composition. The composition appeared as a yellow color liquid suspension, free from any extraneous matter in ambient conditions and retained its identity even after 14 days at 54° C. accelerated heat stability (AHS) conditions. All the three active ingredients (fluindapyr, mancozeb and prothioconazole) remained stable without substantial degradation when analyzed in ambient as well as AHS conditions. Suspensibility of all the active ingredients was found to be more than 85% in both ambient and AHS conditions when analyzed as per the Collaborative International Pesticides Analytical Council (CIPAC) Miscellaneous Techniques (MT) 184. The composition of Example-1 was evaluated to study foam behavior. The resulting composition did not result in any foam. The pH of the composition remained under control within acceptable range. Wet sieve test was performed as per the CIPAC MT 185 and about 99.9% suspension concentrate composition passed the sieve without any noticeable retention on the sieve. Viscosity of the composition was measured using the Brookfield viscometer. Viscosity of the composition of Example-1 was found to be 1241 centipoise (cP) in ambient and 1678 cP in AHS conditions. This was acceptable as per the desired specifications. The particle size appeared to be within acceptable ranges with D₅₀ about 2.03 μm and D₉₀ about 10.76 μm in ambient condition and D₅₀ about 3.09 μm and D₉₀ about 11.75 μm in AHS conditions. (Table-1)

TABLE 1
Physico-chemical characteristics of the composition of Example-1

| | | Specifications | |
|---|---|---|---|
| Sr. | | | 14 Days AHS |
| No. | Parameters | Ambient | (54° C.) |
| 1 | Appearance | Yellow color liquid | Complies |
| | | suspension, free from | |
| | | any extraneous matter | |

Active content (%)

| | | | |
|---|---|---|---|
| 2 | Fluindapyr | 32.60 | 32.78 |
| | Mancozeb | 451.0 | 448.0 |
| | Prothioconazole | 32.80 | 33.30 |

Active suspensibility (%)

| | | | |
|---|---|---|---|
| 3 | Fluindapyr | 97.01 | 85.53 |
| | Mancozeb | 91.13 | 90.60 |
| | Prothioconazole | 92.01 | 85.87 |
| 4 | Persistent foam in | Nil | Nil |
| | 20 ppm (in mL, after | | |
| | 1 minute) | | |
| 5 | pH (1% aqueous | 6.79 | 6.93 |
| | suspension) | | |
| 6 | Wet Sieve test (% w/w | 100 | 99.95 |
| | Material passing through | | |
| | 75-micron test sieve) | | |
| 7 | Viscosity (in cP), | 1241 | 1678 |
| | Brookfield viscometer | | |

Particle size distribution (Micron)

| | | | |
|---|---|---|---|
| 8 | D₅₀ | 2.03 | 3.09 |
| 9 | D₉₀ | 10.76 | 11.75 |

### Example 2: Mancozeb 400 g/L+Tebuconazole 40 g/L+Fluindapyr 28 g/L (SC)

| Ingredients | Quantity (% w/w) |
|---|---|
| Mancozeb | 35.5 |
| Tebuconazole | 3.20 |
| Fluindapyr | 2.25 |
| Propylene Glycol | 4.0 |
| Sodium lignosulphonate | 12.1 |
| Microcrystalline cellulose | 1.2 |
| Soy methyl ester | 1.0 |
| Xanthan gum | 0.14 |
| 1,2-Benzisothiazolin-3-one | 0.2 |
| Polydimethylsiloxane emulsion | 0.7 |
| Water | Q.S. |
| Total | 100 |

### Process:

Fluindapyr, tebuconazole, propylene glycol, about 70% of total quantity of sodium lignosulphonate (dispersing agent) and polydimethylsiloxane emulsion (antifoaming agent) were charged in a vessel along with sufficient quantity of water and stirred to make a homogeneous solution followed by milling to obtain a slurry of a desired particle size. Separately, soy methyl ester was mixed with water and remaining dispersing agents under vigorous stirring to obtain an emulsified soy methyl ester. To the slurry, the emulsified soy methyl ester and microcrystalline cellulose were added to obtain a mill base. Mancozeb was added to the mill base under continuous stirring followed by jellification by adding xanthan gum and 1,2-Benzisothiazolin-3-one (biocide) to obtain the suspension concentrate composition.

### Physico-Chemical Characteristics of the Composition of Example-2

The physico-chemical characteristics of the composition of Example-2 were studied to evaluate stability of the resulting composition. The composition appeared as pale green colour liquid suspension, free from any extraneous matter in ambient conditions and retained its identity when studied after keeping it for 14 days at 54° C., AHS. All the three active ingredients (fluindapyr, mancozeb and tebuconazole) remained stable without substantial degradation when analyzed in ambient as well as AHS conditions. Suspensibility of all the active ingredients was found to be more than 70% in both ambient and AHS conditions when analyzed as per CIPAC MT 184. Due to diverse range of suspensibility of all the three actives, gravimetric suspensibility was also calculated as per MT 184 to ensure overall acceptable suspensibility of the formulation and found to be more than 99%. The composition of Example-2 was further evaluated to study foam behavior. The resulting composition did not result in any foam. The pH remained under control within acceptable range. Wet sieve test was performed as per CIPAC MT 185 and about 99% suspension concentrate composition passed the sieve without any noticeable retention on the sieve. Viscosity was measured using the Brookfield viscometer. Viscosity of the composition of Example-2 was found to be 1216 cP in ambient and 1694 cP in AHS conditions. This was acceptable as per desired specifications. Particle size appeared to be within acceptable range with D₅₀ about 1.73 μm and D₉₀ about 9.81 μm in ambient conditions and D₅₀ about 1.58 μm and D₉₀ about 8.46 μm in AHS condition. (Table-2)

TABLE 2
Physico-chemical characteristics of the composition of Example-2

| | | Specifications | |
|---|---|---|---|
| Sr. | | | 14 Days AHS |
| No. | Parameters | Ambient | (54° C.) |
| 1 | Appearance | Pale green colour liquid | Complies |
| | | suspension, free from | |
| | | any extraneous matter | |

Active content (%)

| | | | |
|---|---|---|---|
| 2 | Fluindapyr | 27.8 | 27.5 |
| | Mancozeb | 408.9 | 394.8 |
| | Tebuconazole | 40.4 | 39.7 |

Active suspensibility (%)

| | | | |
|---|---|---|---|
| 3 | Fluindapyr | 93.60 | 92.02 |
| | Mancozeb | 92.30 | 93.13 |
| | Tebuconazole | 79.13 | 72.46 |
| 4 | Formulation | 100.4 | 99.7 |
| | suspensibility (%) | | |
| 6 | Persistent foam in | Nil | Nil |
| | 20 ppm (in mL, | | |
| | after 1 minute) | | |
| 7 | pH (1% aqueous | 6.48 | 7.3 |
| | Suspension) | | |
| 8 | Wet Sieve test (% | 99.88 | 99.87 |
| | w/w Material passing | | |
| | through 75-micron | | |
| | test sieve) | | |
| 9 | Viscosity (in cP) | 1216 | 1694 |

Particle size distribution (Micron)

| | | | |
|---|---|---|---|
| 10 | D₅₀ | 1.73 | 1.58 |
| 11 | D₉₀ | 9.81 | 8.46 |

### Example 3: Mancozeb 400 g/L+Tebuconazole 27 g/L+Prothioconazole 19 g/L+Fluindapyr 19 g/L (SC)

| Ingredients | Quantity (% w/w) |
|---|---|
| Fluindapyr | 1.60 |
| Mancozeb | 35.5 |
| Tebuconazole | 2.20 |
| Prothioconazole | 1.60 |
| Propylene glycol | 4.00 |
| Sodium lignosulphonate | 12.2 |
| Microcrystalline cellulose | 1.2 |
| Soy methyl ester | 1.0 |
| Xanthan gum | 0.14 |
| 1,2-Benzisothiazolin-3-one | 0.2 |
| Polydimethylsiloxane emulsion | 0.7 |
| Water | Q.S. |
| Total | 100 |

### Process:

Fluindapyr, tebuconazole, prothioconazole, propylene glycol, about 70% of total quantity of sodium lignosulphonate (dispersing agent) and polydimethylsiloxane emulsion (antifoaming agent) were charged in a vessel along with sufficient quantity of water and stirred to make a homogeneous solution followed by milling to obtain a slurry of a desired particle size. Separately, soy methyl ester was mixed with water and remaining dispersing agents under vigorous stirring to obtain an emulsified soy methyl ester. To the slurry, the emulsified soy methyl ester and microcrystalline cellulose were added to obtain a mill base. Mancozeb was added to the mill base under continuous stirring followed by jellification by adding xanthan gum and 1,2-Benzisothiazolin-3-one (biocide) to obtain the suspension concentrate composition.

### Physico-Chemical Characteristics of the Composition of Example-3

The physico-chemical characteristics of the composition of Example-3 were studied to evaluate stability of the resulting composition. The composition appeared as light gray to pale green color liquid suspension, free from any extraneous matter in ambient conditions and retained its identity when studied after keeping it for 14 days at 54° C., AHS. All the four active ingredients (fluindapyr, mancozeb, prothioconazole and tebuconazole) remained stable with substantial degradation when analyzed in ambient as well as AHS conditions. Suspensibility of all the active ingredients was found to be more than 75% in both ambient and AHS conditions when analyzed as per CIPAC MT 184. Due to diverse range of suspensibility of all the three active, gravimetric suspensibility was also calculated as per MT 184 to ensure overall acceptable suspensibility of the formulation and was found to be almost 100%. Composition of Example-3 was further evaluated to study foam behavior. The resulting composition did not result in any foam. The pH remained under control within acceptable range. Wet sieve test was performed as per CIPAC MT 185 and about 99% suspension concentrate passed the sieve without any noticeable retention on the sieve. Viscosity was measured using the Brookfield viscometer. Viscosity of the composition of Example-3 found to be 1086 cP in ambient conditions and 1554 cP in AHS conditions. This was acceptable as per the desired specifications. Particle size appeared to be within acceptable range when measured in ambient condition, D₅₀ was found to be about 1.96 μm and D₉₀ was found to be about 8.9 μm. Similarly, in AHS conditions, D₅₀ was found to be about 1.85 μm and D₉₀ was found to be about 9.9 μm. (Table-3)

TABLE 3
Physico-chemical characteristics of the composition of Example-3

| Sr. | | Specifications | |
|---|---|---|---|
| No. | Parameters | Ambient | 14 Day AHS |
| 1 | Appearance | Light gray to pale | Complies |
| | | green color liquid | |
| | | suspension, free from | |
| | | any extraneous matter | |

Active content (%)

| | | | |
|---|---|---|---|
| 2 | Fluindapyr | 20.6 | 20.2 |
| | Mancozeb | 403.2 | 390.0 |
| | Prothioconazole | 21.0 | 20.6 |
| | Tebuconazole | 29.6 | 28.8 |

Active suspensibility (%)

| | | | |
|---|---|---|---|
| 3 | Fluindapyr | 90.8 | 89.2 |
| | Mancozeb | 91.9 | 93.2 |
| | Prothioconazole | 80.3 | 75.6 |
| | Tebuconazole | 81.9 | 80.3 |
| 4 | Gravimetric | 100.4 | 100.3 |
| | suspensibility (%) | | |
| 6 | Persistent foam in | Nil | Nil |
| | 20 ppm (in mL, after | | |
| | 1 minute) | | |
| 7 | pH (1% | 6.1 | 7.22 |
| | aqueous Suspension) | | |
| 8 | Wet Sieve test (% w/w | 99.88 | 99.87 |
| | Material passing through | | |
| | 75- micron test sieve) | | |
| 9 | Viscosity (in cP) | 1086 | 1554 |

Particle size distribution (micron)

| | | | |
|---|---|---|---|
| 10 | D₅₀ | 1.96 | 1.85 |
| 11 | D₉₀ | 8.9 | 9.90 |

### Comparative Examples 4, 5 and 6: Mancozeb 400 g/L+Tebuconazole 40 g/L+Fluindapyr 28 g/L (SC)

To understand the role of an unsaturated lipid and an additive, several compositions were prepared without adding either of the unsaturated lipid or the additive; or without adding both these components. The physico-chemical profile of these compositions were evaluated and compared with the compositions comprising unsaturated lipid and additive.

Therefore, Examples 4, 5 and 6 are comparative examples; wherein in Example-4 the composition was prepared without addition of soy methyl ester; in Example-5 the composition was prepared without addition of microcrystalline cellulose; and in Example-6 the composition was prepared without addition of both microcrystalline cellulose and soy methyl ester.

| | Example-4 | Example-5 | Example-6 |
|---|---|---|---|
| Ingredients | Quantity (% w/w) | | |
| Mancozeb | 35.5 | 35.5 | 35.5 |
| Tebuconazole | 3.20 | 3.20 | 3.20 |
| Fluindapyr | 2.25 | 2.25 | 2.25 |
| Propylene Glycol | 4.0 | 4.0 | 4.0 |
| Sodium lignosulphonate | 12.0 | 12.0 | 12.0 |
| (dispersing agent) | | | |
| Microcrystalline cellulose | 1.00 | — | — |
| Soy methyl ester | — | 1.0 | — |
| Xanthan gum | 0.14 | 0.14 | 0.14 |
| 1,2-Benzisothiazolin-3-one | 0.20 | 0.20 | 0.20 |
| Polydimethylsiloxane emulsion | 0.70 | 0.70 | 0.70 |
| (antifoaming agent) | | | |
| Water | Q.S. | Q.S. | Q.S. |
| Total | 100 | 100 | 100 |

With respect to stability of active ingredients, compositions of Example 4 to 6 did not show substantial degradation and were found satisfactory in ambient and AHS conditions. Upon testing the resulting compositions in ambient condition, all the three compositions were found to have satisfactory viscosity in a range of 1000-1500 cP.

Contrastingly, when samples were analyzed upon keeping them for 14 days at 54° C., AHS, substantial rise in viscosity was observed. Compositions became too thick with resulting viscosity in a range of 2000-3500 cP. These compositions were not found suitable due to unsatisfactory product profile. (Table-4)

TABLE 4
Physico-chemical characteristics of the
composition of Examples 4, 5 and 6

| | | Example-4 | | Example-5 | | Example-6 | |
|---|---|---|---|---|---|---|---|
| | | | 14 | | 14 | | 14 |
| Sr. | Para- | Am- | Days | Am- | Days | Am- | Days |
| No. | meters | bient | (AHS) | bient | (AHS) | bient | (AHS) |
| 1 | Viscosity | 1158 | 3388 | 1426 | 3124 | 1010 | 2275 |
| | (in cP) | | | | | | |

Particle size distribution (Micron)

| | | | | | | | |
|---|---|---|---|---|---|---|---|
| 2 | D₅₀ | 2.25 | 2.58 | 1.21 | 2.96 | 2.13 | 1.91 |
| 3 | D₉₀ | 9.81 | 11.80 | 10.6 | 17.10 | 11.0 | 11.10 |

Therefore, the inventors of the present invention have successfully developed stable agrochemical composition of a pyrazolecarboxamide fungicide in combination with at least one additional fungicide; wherein presence of an unsaturated lipid and an additive resulted into better stabilization of the suspension concentrate compositions comprising pyrazolecarboxamide fungicide. The agrochemical compositions demonstrated suspensibility and dispersibility upon dilution. The active ingredients were found to remain quite stable after preparation and even during storage studies. Moreover, the agrochemical composition was found to have stable viscosity profile resulting into easy pourability from container and negligible chances of nozzle choking.

### Example 7: Mancozeb 450 g/L+Prothioconazole 30 g/L+Bixafen 30 g/L (SC)

| Ingredients | Quantity (% w/w) |
|---|---|
| Bixafen | 2.6 |
| Mancozeb | 41.2 |
| Prothioconazole | 2.6 |
| Propylene glycol | 4.0 |
| Sodium lignosulphonate | 4.2 |
| Microcrystalline cellulose | 1.50 |
| Vegetable oil | 5.00 |
| Xanthan gum | 0.10 |
| 1,2-Benzisothiazolin-3-one | 0.10 |
| Polydimethylsiloxane emulsion | 0.20 |
| Water | Q.S. |
| Total: | 100 |

### Process:

Bixafen, prothioconazole, propylene glycol, about 70% of total quantity of sodium lignosulphonate (dispersing agent) and polydimethylsiloxane emulsion (antifoaming agent) were charged in a vessel along with sufficient quantity of water and stirred to make a homogeneous solution followed by milling to obtain a slurry of a desired particle size. Separately, oil was mixed with water and remaining dispersing agents under vigorous stirring to obtain an emulsified oil. To the slurry, the emulsified oil and microcrystalline cellulose were added to obtain a mill base. Mancozeb was added to the mill base under continuous stirring followed by jellification by adding xanthan gum and 1,2-Benzisothiazolin-3-one (biocide) to obtain the suspension concentrate composition.

### Physico-Chemical Characteristics of the Composition of Example-7

The physico-chemical characteristics of the composition of Example-7 were studied to evaluate stability of the resulting composition. The composition appeared as yellow color liquid suspension, free from any extraneous matter in ambient conditions and retained its identity when studied after keeping it for 14 days at 54° C., AHS. All the three active ingredients (Bixafen, mancozeb and prothioconazole) remained stable with substantial degradation when analyzed in ambient as well as AHS conditions. Suspensibility of all the active ingredients was found to be more than 75% in both ambient and AHS conditions when analyzed as per CIPAC MT 184. Composition of Example-7 was further evaluated to study foam behavior. The resulting composition did not result in any foam. The pH remained under control within acceptable range. Wet sieve test was performed as per CIPAC MT-185 and about 99% suspension concentrate passed the sieve without any noticeable retention on the sieve. This was acceptable as per the desired specifications. Particle size appeared to be within acceptable range when measured in ambient condition, D₅₀ was found to be about 1.89 μm and D₉₀ was found to be about 7.89 μm. Similarly, in AHS condition, D₅₀ was found to be about 2.01 μm and D₉₀ was found to be about 6.80 μm. (Table-5)

TABLE 5
Physico-chemical characteristics of the composition of Example-7

| Sr. | | Specifications | |
|---|---|---|---|
| No. | Parameters | Ambient | 14 Day AHS |
| 1 | Appearance | Yellow colour liquid | Complies |
| | | suspension, free from | |
| | | any extraneous matter | |

Active content (%)

| | | | |
|---|---|---|---|
| 2 | Mancozeb | 455.60 | 452.3 |
| | Prothioconazole | 37.33 | 35.98 |
| | Bixafen | 32.76 | 30.88 |

Active suspensibility (%)

| | | | |
|---|---|---|---|
| 3 | Mancozeb | 94.10 | 87.20 |
| | Prothioconazole | 99.00 | 92.16 |
| | Bixafen | 99.95 | 93.98 |
| 4 | Density (g/mL) | 1.34 | — |
| 5 | Persistent foam in | Nil | Nil |
| | 20 ppm (In mL, after | | |
| | 1 minute) | | |
| 6 | pH (1% aqueous | 6.77 | 7.21 |
| | suspension) | | |
| 7 | Wet Sieve test | 99.90 | 99.80 |
| | (% w/w Material passing | | |
| | through 75-micron | | |
| | test sieve) | | |

Particle size distribution (micron)

| | | | |
|---|---|---|---|
| 8 | D₅₀ | 1.89 | 2.01 |
| 9 | D₉₀ | 7.89 | 6.80 |

Therefore, the inventors of the present invention successfully developed various agrochemical compositions in the form of suspension concentrates of a pyrazolecarboxamide fungicide, in combination with at least one additional fungicide using an unsaturated lipid and an additive. The agrochemical compositions demonstrated better suspensibility and dispersibility. The active ingredients were found to remain quite stable after preparation and even during storage studies. The pH of the composition remained quite stable.

1. An agrochemical composition comprising:
(a) at least one pyrazolecarboxamide fungicide or a derivative thereof,
(b) at least one additional fungicide or a derivative thereof;
(c) an unsaturated lipid or a derivative thereof; and
(d) an additive.

2. The composition as claimed in claim 1, wherein said pyrazolecarboxamide fungicide is selected from the group comprising benzovindiflupyr, bixafen, flubeneteram, fluindapyr, fluxapyroxad, furametpyr, inpyrfluxam, isopyrazam, penflufen, penthiopyrad, pydiflumetofen, sedaxane, or derivatives thereof.

3. The composition as claimed in claim 1, wherein said composition comprises from about 0.1% w/w to about 30% w/w pyrazolecarboxamide fungicide of total weight of said composition.

4. The composition as claimed in claim 1, wherein said additional fungicide is selected from the group comprising dithiocarbamate, azole, benzimidazole, strobilurin, copper, copper compounds, or derivatives thereof.

5. The composition as claimed in claim 1, wherein said additional fungicide is selected from the group comprising azoxystrobin, trifloxystrobin, fluoxastrobin, pyraclostrobin, prothioconazole, tebuconazole, ipconazole, penconazole, mancozeb, maneb, zineb, copper, basic copper sulfate, tribasic copper sulphate, bordeaux mixture, copper hydroxide, copper oxychloride, cuprous oxide, mancopper, or derivatives thereof.

6. The composition as claimed in claim 1, wherein said composition comprises from about 10% w/w to about 90% w/w additional fungicide of total weight of said composition.

7. The composition as claimed in claim 1, wherein said unsaturated lipid comprises esters of fatty acids with glycerol selected from the group comprising plant oil, vegetable oil, modified plant oil, modified vegetable oil, or combinations thereof.

8. The composition as claimed in claim 7, wherein said unsaturated lipid is selected from the group comprising soya bean oil, rapeseed oil, maize germ oil, maize kernel oil, sunflower oil, cottonseed oil, linseed oil, coconut oil, palm oil, canola oil, castor oil, soy methyl ester, rapeseed methyl ester, palm methyl ester, palm kernel methyl ester, coconut methyl ester, C₈₋₁₀ methyl ester, or combinations thereof.

9. The composition as claimed in claim 1, wherein said composition comprises from about 0.1% w/w to about 25% w/w unsaturated lipid of total weight of said composition.

10. The composition as claimed in claim 1, wherein said additive is selected from the group comprising clay, modified clay, high surface area silica, starch, modified starch, cellulose, modified cellulose, or mixtures thereof.

11. The composition as claimed in claim 1, wherein said composition comprises from about 0.01% w/w to about 10% w/w additive of total weight of said composition.

12. The composition as claimed in claim 1, wherein said composition is in a form of a suspension concentrate (SC).

13. The composition as claimed in claim 1, wherein said composition comprises viscosity ranging from about 1000 centipoise to about 2000 centipoise.

14. A suspension concentrate comprising:
(a) fluindapyr or bixafen;
(b) at least one additional fungicide selected from the group comprising azoxystrobin, trifloxystrobin, fluoxastrobin, pyraclostrobin, prothioconazole, tebuconazole, ipconazole, penconazole, mancozeb, maneb, zineb, copper, basic copper sulfate, tribasic copper sulphate, bordeaux mixture, copper hydroxide, copper oxychloride, cuprous oxide, mancopper, or derivatives thereof,
(c) an unsaturated lipid or a derivative thereof, and
(d) an additive selected from the group comprising clay, modified clay, high surface area silica, starch, modified starch, cellulose, modified cellulose, or mixtures thereof.

15. The composition as claimed in claim 14, wherein said composition comprises:
(a) fluindapyr;
(b) mancozeb;
(c) at least one additional fungicide selected from prothioconazole, tebuconazole, or combinations thereof,
(d) soy methyl ester, and
(e) modified cellulose.

16. The composition as claimed in claim 14, wherein said composition comprises:
(a) bixafen;
(b) mancozeb;
(c) at least one additional fungicide selected from prothioconazole, tebuconazole, or combinations thereof,
(d) vegetable oil, and
(e) modified cellulose.

17. A process of preparing an agrochemical composition, said process comprising:
(a) mixing, and optionally blending and milling, at least one pyrazolecarboxamide fungicide, at least one additional fungicide, an unsaturated lipid, an additive and water to obtain a mixture;
(b) adding to the mixture of step (a) a separately prepared gel to obtain the agrochemical composition.

18. The process as claimed in claim 17, wherein said process comprises:
(a) mixing, and optionally blending, fluindapyr or bixafen; at least one additional fungicide selected from the group comprising prothioconazole, tebuconazole, mancozeb, azoxystrobin, copper, or copper compounds; the unsaturated lipid; the additive; optionally other agrochemically acceptable excipients; and water to obtain a mixture;
(b) milling the mixture of step (a) to obtain a slurry with a desired particle size;
(c) separately, preparing a gel by adding a thickener and a biocide in water; and
(d) adding the gel of step (c) to the slurry of step (b) to obtain the agrochemical composition.

19. A method of controlling phytopathogenic fungal diseases by applying to a plant or locus or plant propagation material thereof, the agrochemical composition of claim 1.

20. The method as claimed in claim 19, wherein said method comprises: (a) at least one pyrazolecarboxamide fungicide selected from fluindapyr or bixafen; (b) at least one additional fungicide selected from the group comprising prothioconazole, tebuconazole, mancozeb, azoxystrobin, copper, or copper compounds; (c) an unsaturated lipid comprising esters of fatty acids with glycerol; and (d) an additive.

21. (canceled)
